(19) United States
(12) Patent Application Publication
(10) Pub. No.: US 2023/0206337 A1
(43) Pub. Date: Jun. 29, 2023

(54) ENERGY TRADING SYSTEM

(71) Applicant: Hygge Energy Inc., Cupertino, CA (US)

(72) Inventors: Rajagopalan Krishnamurthy, Cupertino, CA (US); Sundara Raju Giridhar Bangalore, Mumbai (IN)

(21) Appl. No.: 18/146,017

(22) Filed: Dec. 23, 2022

Related U.S. Application Data
(60) Provisional application No. 63/293,362, filed on Dec. 23, 2021.

(51) Int. Cl. G06Q 40/06; G06Q 50/06; G06Q 20/38; G06Q 20/06

(52) U.S. Cl. CPC G06Q 40/06; G06Q 20/065; G06Q 20/381; G06Q 20/389; G06Q 50/06; G06Q 2220/00

(57) ABSTRACT

A energy trading system comprising three sub-systems, which generate three different tokens, i.e. investment tokens, consumer tokens and power tokens. While a standard application contains all three tokens, their processes or sub-systems may fit together in a number of made-to-order configurations containing anywhere between one to three tokens able to meet any set of business requirements. The decoupling of the tokens enables an adjustment to a multitude of existing industry frameworks as well location-specific regulations. Additionally, unlike other platforms, the power tokens are not subject to the price volatility of tokens on a crypto-currency exchange, which reduces operational risk for project operators. Altogether, the system provides a very stable and bankable value for investors as well as a stable price for power and value to the end consumers.

### TECHNICAL FIELD

The present disclosure relates to an energy trading system, and in particular to a peer to pear tokenized energy trading system.

### BACKGROUND

Traditionally, energy generation infrastructure investment has been made by public entities on long lifetime terms, often supported by favorable tax and depreciation rules. Sometimes these are done in partnership with private entities under specific long-duration terms. For example, when a private entity invests to build a natural gas plant to serve a community, the utilities commission and others may limit how much return can be made on that investment but will also guarantee that there will be uptake of the energy produced so that there is an assured minimum return on the investment.

Traditional energy delivery includes transmission and distribution systems, which refers to installing, operating and maintaining the wires and electrical infrastructure required to safely and reliably deliver energy to end consumers. The companies that perform this function are typically well regulated or overseen since energy is an essential utility. Energy delivery companies typically make a margin on the use of this infrastructure while, for the most part, passing through the aggregate cost of procuring the energy flowing through their systems. They deal with diverse categories of end consumers and support the local state and community mandates relating to income, clean energy, safe energy and other relevant initiatives including local financial regulations.

Thanks to falling costs and numerous policies and incentives geared toward promoting greater renewable energy supply, recent years have seen an increase in distributed energy resources (DERs) installations all over the world. Naturally, the number of prosumers, i.e. consumers who also produce energy, is growing. Feed-in-tariff (FIT) and net-metering (NM)) schemes allow prosumers to sell their excess energy back to the grid for an economic return which, for a few years after implementation, remains significantly higher than the average cost of energy to the consumer. However, as effective as they have been in the past, industry members are increasingly calling to end FIT and NM. They argue that it is no longer necessary to subsidize renewable energy as costs have fallen considerably over the last few years. Countries such as Germany and the UK have retired their FIT schemes, citing among other concerns the need for more market-driven sources of support for renewable energy promotion. It is no surprise, therefore, that peer-to-peer energy markets, i.e. community markets where prosumers can trade their excess energy directly to their neighbors, are gaining traction.

Typical DER and microgrids are owned by customers or utilities. There are very few, if any, funding options for projects beyond direct ownership by utility or prosumers. Currently, DERs owners are compensated for their production by the utility under outdated programs which increasingly do not reflect the economics of the energy market. Additionally, consumption and production records are generated and maintained by the utilities with limited transparency. Bills are generated and issued using unwieldy legacy systems. Lastly, energy consumers are given a limited number of payment options for settling their bills.

An object of the present disclosure is to provide an energy trading system that includes decoupled sub-systems and is untethered from specific crypto-currencies.

### SUMMARY

Accordingly, a first method includes an energy trading method comprising:
utilizing a first processor, executing instruction stored on a first non-transitory memory configured to generate investment tokens for investors, who have funded an energy production project, and storing a record of the investment tokens on a first blockchain memory;
utilizing a second processor, executing instruction stored on a second non-transitory memory configured to generate power tokens in response to receiving sensor data from sensors at the energy production project as a record of energy production by the energy production project, and storing a record of the power tokens on a second blockchain memory;
utilizing a third processor, executing instruction stored on a third non-transitory memory configured to generate consumer tokens for consumers in exchange for currency for purchasing power tokens, and storing a record of the consumer tokens on a third blockchain memory; and
providing power to consumers in exchange for an amount of consumer tokens;
providing compensation to the investors as the power tokens are generated;
wherein the investment tokens the power tokens and the consumer tokens are untethered to any one cryptocurrency.

According to any of the aforementioned embodiments the method may further comprise purchasing power from a consumer in exchange for a power token.

According to any of the aforementioned embodiments the first blockchain memory, the second blockchain memory and the third blockchain memory may each comprise redundant block chain memories.

According to any of the aforementioned embodiments the method may further comprise measuring the amount of power provided to the consumer with a power meter at the consumer’s location.

Accordingly, a first apparatus comprises an energy trading system comprising:
a first processor, executing instruction stored on a first non-transitory memory configured to generate investment tokens for investors, who have funded an energy production project, and storing a record of the investment tokens on a first blockchain memory;
a sensor for generating sensor data as power as a record of energy production by the energy production project;
a second processor, executing instruction stored on a second non-transitory memory configured to generate power tokens in response to receiving the sensor data, and storing a record of the power tokens on a second blockchain memory;
the first processor also configure to exchange investment tokens for compensation as the power tokens are generated in response to the sensor data; and
a third processor, executing instruction stored on a third non-transitory memory configured to generate consumer tokens for consumers in exchange for currency for purchasing power tokens, and storing a record of the consumer tokens on a third blockchain memory, and configured to provide power to consumers in exchange for an amount of consumer tokens;
wherein the investment tokens the power tokens and the consumer tokens are untethered to any one cryptocurrency.

According to any of the aforementioned embodiments the system may further comprise a power storage device configured for receiving power from a consumer in exchange for a power token.

According to any of the aforementioned embodiments the first blockchain memory, the second blockchain memory and the third blockchain memory may each comprise redundant block chain memories.

According to any of the aforementioned embodiments the system mat further comprise a power meter at each consumer’s location configured for measuring the amount of power provided.

### BRIEF DESCRIPTION OF THE DRAWINGS

Some example embodiments will be described in greater detail with reference to the accompanying drawings, wherein:

FIG. 1 is a schematic diagram of an energy trading system of the present disclosure;

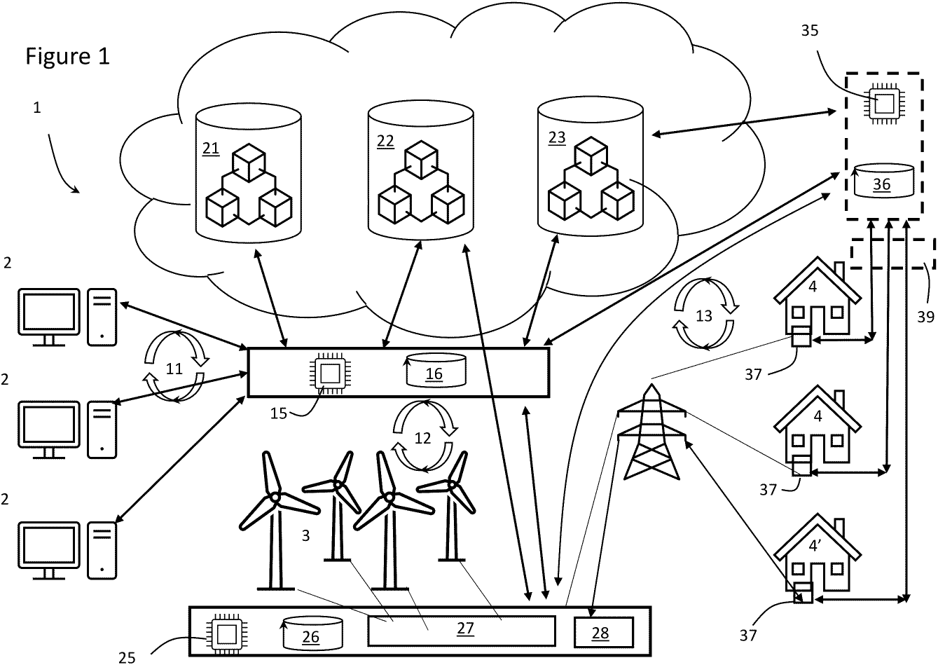

FIG. 2 is a schematic diagram of an energy trading system of the present disclosure;

FIG. 3 is a schematic diagram of an energy trading system of the present disclosure;

FIG. 4 is a schematic diagram of an energy trading system of the present disclosure;

FIG. 5 is a schematic diagram of an energy trading system of the present disclosure;

FIG. 6 illustrates a production transaction 1800 in accordance with one embodiment.

FIG. 7 illustrates a consumption transaction 1900 in accordance with one embodiment.

FIG. 8 illustrates an allocation transaction 2000 in accordance with one embodiment.

FIG. 9 illustrates a block example 2100 in accordance with one embodiment.

FIG. 10 illustrates a connection infrastructure 2200 in accordance with one embodiment.

FIG. 11 illustrates a Utility and power flow diagram 2300 in accordance with one embodiment.

FIG. 12 illustrates an Investment flow and power flow diagram 2400 in accordance with one embodiment.

FIG. 13 illustrates a power flow and consumer flow diagram 2500 in accordance with one embodiment.

FIG. 14 illustrates an investment flow, power flow and consumer flow diagram 2600 in accordance with one embodiment.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

An energy trading system 1 of the present disclosure comprises a platform for a tokenized energy market in which tokens are used to buy and sell energy. The energy trading system 1 utilizes three different sub-systems with three different types of tokens, e.g. an investment sub-system 11 with investment tokens, a power sub-system 12 with power tokens, and a consumer sub-system 13 with consumer tokens, with some independent processes that enable local laws, regulations and business practices to be honored. Investment tokens are a way for local, community or remote investors 2 to fund energy projects 3 and may be traded for power tokens. Power tokens are records of energy production. Consumers tokens may be purchased and traded by consumers 4 for power tokens in the marketplace. In other words, each token represents one of the three major aspects of energy infrastructure and delivery: infrastructure investment, energy generation, and energy delivery and billing. The energy project 3 may be any form of renewable energy project, e.g. solar or wind, and any form of non-renewable energy project, e.g. natural gas or coal.

While a standard application of the present system includes all three sub-systems with three different types of tokens, their processes, or sub-systems, may fit together in several made-to-order configurations containing anywhere between one to three tokens able to meet any set of business requirements. Decoupled sub-systems 11, 12 and 13 are better suited to real world solutions where disparate parts need to comply with different rules and regulations as well as differing time intervals. For example, Investment returns occur in quarterly, annual or even longer periods while energy is traded in milli seconds throughout the day and Consumers buy and pay for energy on a monthly basis.

An investment sub-system 11 utilizes the investment tokens as a way for local, community or remote investors to fund projects. Conventional DER and microgrids are owned by customers or utilities and save money for the customer or generate revenue for the utility. The investment sub-system 11 includes a controller processor 15 and a non-transitory memory 16, which stores computer software instructions, which when executed by the controller processor 15 provides the investors 2 an interface to purchase, e.g. bid on or buy outright, portions of energy projects 3 via a suitable communications network, e.g. the internet. Record of the transaction for the investment tokens and the ownership of the energy project 3 is recorded by the controller processor 15 on an investment blockchain memory database 21. The investment tokens expand funding options for projects beyond direct ownership by utility or prosumers. Anyone on the platform may invest and investments may be of any size. This dramatically increases the universe of investors and promotes green energy deployment. Local, community, or remote investors may purchase investment tokens using fiat or digital currency. A specific energy production project may be given a predetermined cost, e.g. $100,000 US$, which may correspond to a predetermined number of investment tokens, e.g. 100, based on a guaranteed base rate contract. Each investors may receive a percentage of the total number of investment tokens based on their percentage of the total cost of the project, e.g. $10,000 investment = 10 investment tokens, plus their percentage of any bonuses that the energy production project generates based on selling the energy at a premium rate above the base rate. Each investor’s investment tokens may be initially locked, and then released over the lifetime of the project as the power is produced by the project. The investment tokens may be sold for currency, e.g. fiat or crypto-currency, or converted into power tokens based on the current exchange rate. For example, at regular or irregular time intervals, e.g. weekly, monthly or yearly, the power sub-system 12 generates power tokens corresponding to the amount of power generated in that time period, which are transferred to the investor’s as compensation, e.g. in some form of currency, in accordance with a predetermined exchange rate of investor tokens for power tokens. The power tokens may then be sold as hereinafter described.

The power sub-system 12 may be comprised of one or more controller processors, e.g. the controller processor 15 or other suitable controller processor 25, which may communicate with the controller processor 15 over a suitable communication network, and a non-transitory memory, e.g. the non-transitory memory 16 or other suitable non-transitory memory 26, which stores computer software instructions, which when executed by the controller processor 15 or 25 is configured to monitor the production of power from the energy project 3 and generate power tokens as records of energy production, e.g. kWh. A power monitor or sensor 27 measures energy output from the energy project 3, and the controller processor 15 or 25 may record the data as power tokens in a resilient two-layer lightweight embedded blockchain 22. The power tokens may then be sold on the platform to consumers 4 and the proceeds distributed to the investors 2 in exchange for their investor tokens based on a predetermined exchange rate.

Prosumers 4′, i.e. consumers who may also produce excess power, may also sell power to the power sub-system 12 in exchange for power tokens or currency. The acquired power may be stored in batteries 28 for subsequent sale to other consumers 4. Currently, prosumers are compensated for their production by the utility. The system 1 creates a marketplace in which prosumers 4′ may sell their energy directly to the consumers 4 instead.

Additionally, the power tokens are not subject to price volatility of conventional power exchanges, thereby reducing any risk for operators. When conventional power exchanges are tied to a crypto-currency traded on an exchange, they can experience massive price volatility which represents a huge operational risk. For example, if the price of the crypto-currency swings upward, the system 1 over-pays prosumers 4′ for the energy it buys. If the cost of the crypto-currency swings downward, prosumers 4′ receive far less for the energy they sell than what it is worth. Accordingly, the investors 2 are not required to purchase or maintain reserves of any blockchain currency to operate the system. Alternatively, the present solution provides a very stable and bankable value for investors 2 as well as a stable price for power and value to the end consumers 4. In conventional power exchanges that are tied to crypto-currency traded on an exchange, there is an operational cost of priming the system with the requisite number of power tokens that must be procured at market price in order to use them in the power loop. The operational cost of this pool of tokens can vary wildly due to being tethered to the underlying crypto-currency. In the proposed approach, there are clearly bounded operational costs relating to the running of these systems, which are undisturbed by any fluctuation of local currency or blockchain currencies. Accordingly, the present invention is untethered from any one crypto-currency to eliminate this shortcoming.

The consumer sub-system 13 may be comprised of a controller processor, e.g. the controller processor 15 or 25 or other suitable controller processor 35, which may communicate with the other one or more controller processors 15 and 25 over a suitable communication network, and a non-transitory memory, e.g. the non-transitory memory 16 or 26 or other suitable non-transitory memory 36, which stores computer software instructions, which when executed by the controller processor 15, 25 or 35 is configured to provide an interface from which consumers 4 may purchase consumer tokens for purchasing power tokens at a predetermined exchange rate. Consumer tokens may be purchased with fiat or digital currency by the consumers 4 in our trading app. Consumers then trade these tokens for energy in our marketplace. The controller processor 15, 25 and/or 35 may record the consumer data as consumer tokens in a resilient two-layer lightweight embedded blockchain 23. Each consumer 4 or 4′ may receive a power meter or sensor 37 for locating at their location for controlling, measuring and/or recording the amount of power purchased and/or consumed by the respective consumer 4. Each power meter or sensor 37 at each consumer’s location may be in communication with the controller processor 15, 25 or 35 via suitable network, e.g. the internet, and with the consumer’s internal network via suitable network, e.g. Wi-Fi.

Traditionally, utilities track their customers’ consumption and use legacy systems to generate and issue bills to their customers. Consumers are given a limited number of payment options for settling their bills. The tokenized system 1 expands the payment options available to customers to include digital currencies. Additionally, the system 1 reduces high overhead costs associated with traditional payment options. Also, by not anchoring the consumer tokens to any blockchain currency, the relationship of prepaid consumer tokens to the local currency value may be maintained, while meeting local regulations, which can vary widely.

The consumer subsystem 13, e.g. the controller processor 15, 25 and/or 35, may be configured to generate invoices and receive payments directly from the consumers 4. Alternatively, in accordance with local regulations, a local utility company 39 may at as a gobetween and generate the invoices and receive the payments, which may then be passed on to the consumer subsystem 13.

While the sub-systems 11, 12 and 13 were designed to work together, they can also work independently from one another. In fact, several made-to-order configurations containing anywhere between one to three sub-systems 11, 12 and 13 and corresponding tokens may be provided depending on the business requirements of a project.

For instance, in the standard solution with all three sub-systems 11, 12 and 13, the platform may replace legacy billing methods used by the local utility company 39 as well as traditional ways to invest in solar or wind infrastructure for energy project 3, while also providing a robust system for tracing energy production and allocation. Decoupled sub-systems 11. 12 and 14 may be better suited to real world solutions where disparate parts need to comply with different rules and regulations as well as differing time intervals. For example, Investment returns occur in quarterly, annual or even longer periods while energy is traded in milli seconds throughout the day and Consumers buy and pay for energy on a monthly basis

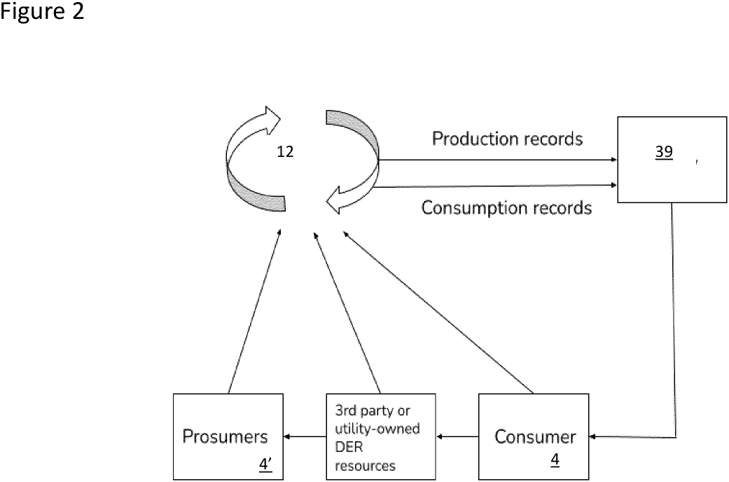

With reference to FIG. 2, in a configuration with only the power sub-system 12 and the investment sub-system 11, consumers 4 are billed for their use of energy in the traditional way by the local utility company 39 using the records provided to them by the power sub-system 12. This flexibility allows the system 1 to operate within well-established industry frameworks as well as innovative regulatory frameworks. Additionally, the separation of the investment, power and consumer tokens enables the creation of consumer token offerings or investment token offerings based on what is optimal for each project.

The power subsystem 12, e.g. the controller processor 25, receives sensor data from the sensors 27 of the consumers 4, prosumers 4′ and/or other DERs, and trades the energy available accordingly. The power sub-system 12, e.g. the controller processor 25, is a token or coin-based workflow that handles all the energy transactions, generates production records and consumption records and sends them to the local utility company 39. This data is used to generate traditional records for billing and credits by the local utility company 39.

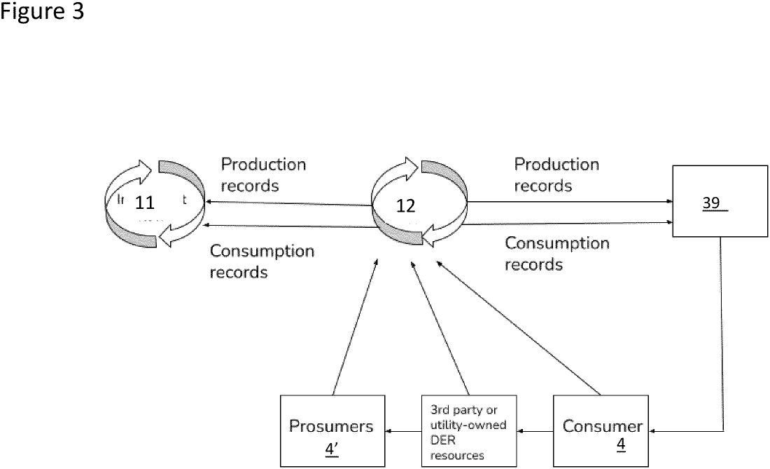

With reference to FIG. 3, in a system including only an investment sub-system 11 and a power sub-system 12, the investment sub-system 11 is a token or coin-based workflow to facilitate and manage investment into infrastructure and return value over its lifetime. The energy produced by the DERs is traded using the power sub-system 12 and the corresponding value is delivered to the investors 2 using the investment sub-system 11. In this configuration, consumers 4 and prosumers 4′ are billed for their use of energy in the traditional way using the production records and consumption records given to local utility company 39 by the power sub-system 12. By combining the power sub-system 12 and the investment sub-system 11, a method is created to convert real money and other investments into a form that may be transacted within the power subsystem 12 and returns may be converted back to the investors 2 via the investment sub-system 11.

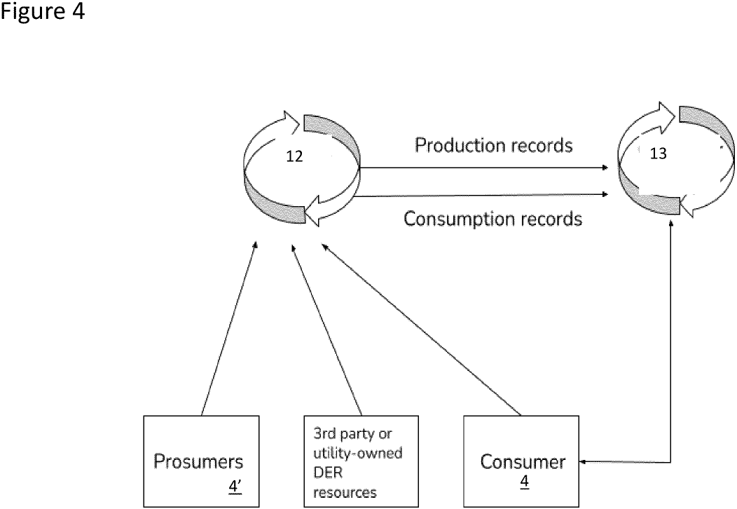

With reference to FIG. 4, in a system including only a power sub-system 12 and a consumer sub-system 13, the consumer sub-system 13 is a token or coin-based workflow to facilitate energy purchase by the end consumer 4. The power sub-system 12 handles all the energy transactions, generates production records and consumption records and sends them to the consumer sub-system 13. Consumers 4 and prosumers 4′ use a tokenized or digital currency to pay or pre-pay for their energy use through the consumer sub-system 13. In this configuration, infrastructure investment is performed in the traditional manner where the local utility company 39, developers, prosumers 4′ and other third parties may spend their own capital for energy infrastructure and don’t participate in an investment.

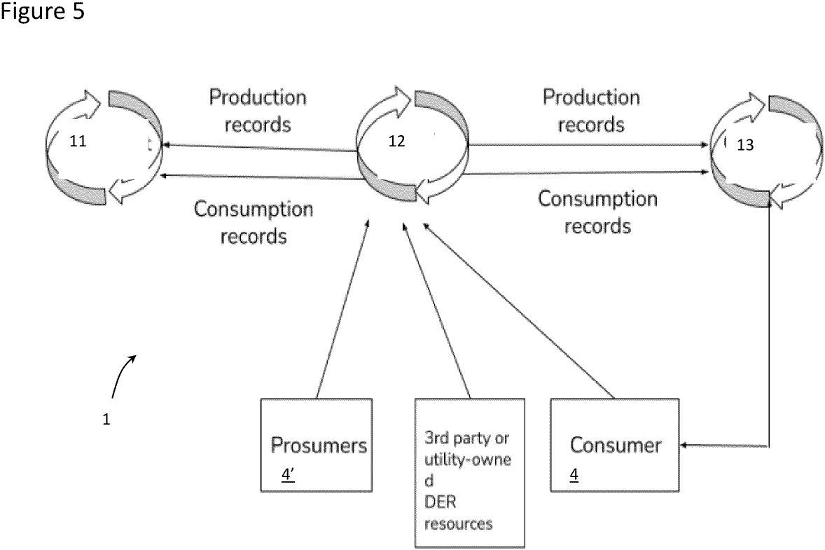

With reference to FIG. 5, the system includes the investment sub-system 11, the power sub-system 12 and the consumer sub-system 13 are all in place. The entire system 1 may now be based on a digital currency or tokens. Investments in energy infrastructure may be made using crypto currency or tokens. The energy produced by the DERs may be traded using the power subsystem 12 and the corresponding value is delivered to the investor 2 using the investment subsystem 11. Consumers 4 and prosumers 4′ may use a tokenized or digital currency to pay for or prepay for their energy use through the consumer sub-system 13. The power token bridges the interface between the investment tokens and the consumer tokens, whereby the power sub-system 12 sends production records and consumption records to both the investment sub-system 11 and the consumer sub-system 13.

The system 1 connects the local utility company 39, energy projects 3, consumers 4 and prosumers 4′ for easy, direct energy transactions by using proprietary blockchain technology to certify, validate and execute transactions between consumers 4 and energy projects 3. The two-layer blockchain 22 stores sensor measurements from sensors 27 as power tokens, which may be shared with distribution network operators and energy suppliers resulting in traceable green energy generation and accurate billing. The pool of investors may be expanded beyond direct ownership by implementing a tokenized investment solution. Investors buy into projects by buying investment tokens. In exchange for their investment, they receive a lifetime’s production worth of power tokens. The investment tokens are locked and are released as production from the power producing projects is settled by actual production and trade. Consumers 4 and prosumers 4′ use a tokenized or digital currency to pay for or prepay for their energy use. While a standard application of the system 1 contains all three tokens, their processes, or sub-systems 11, 12 and 13, may fit together in a number of made-to-order configurations containing anywhere between one to three tokens able to meet any set of business requirements. The decoupling of the tokens from each other enables adjustment to a multitude of existing industry frameworks as well location-specific regulations. Additionally, unlike other platforms, the power tokens are not subject to the price volatility of tokens on an exchange, which reduces operational risk for project operators. Altogether, the system 1 provides a very stable and bankable value for investors as well as a stable price for power and value to the end consumers.

Further details of the token system, and an energy distribution system in which the Energy Trading System of the present disclosure may be utilized may be found in the following specification.

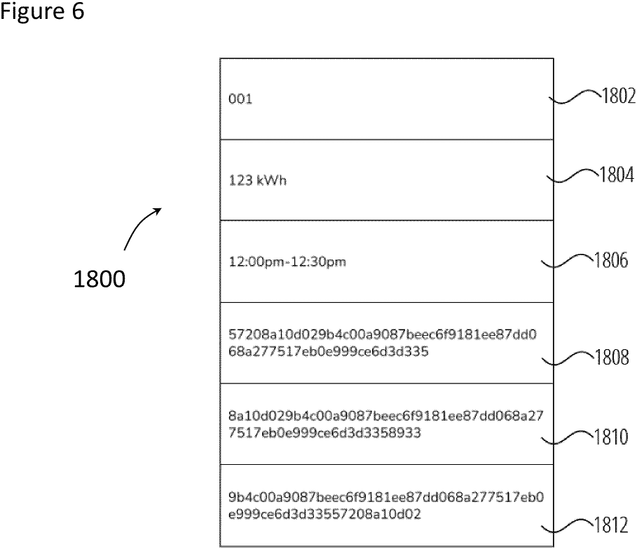

FIG. 6 illustrates a production transaction 1800 as in one embodiment. A production transaction is a log of a sensor measurement. In an extended context, this transaction could be termed outgoing transaction. It contains the following data points: the production transaction id 1802, the production sensor measurement 1804, the production time period 1806, the production token key-pair (the production public key 1808 and the production private key 1810) and the private key production output ID 1812. For example, Node 1′s sensor measured x amount for time period y. Node 1 would then add this measurement to the blockchain using production token w, which proves the node is able to transact this energy.

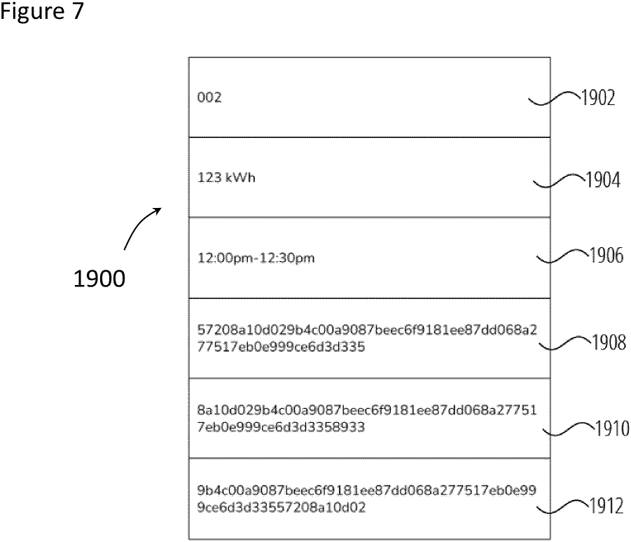

FIG. 7 illustrates a consumption transaction 1900 as in one embodiment. A consumption transaction is a log of a sensor measurement. In an extended context, this transaction could be termed incoming transaction. It contains the following data points: the consumption transaction id 1902, the consumption sensor measurement 1904, the consumption time period 1906, the consumption token key-pair (the consumption public key 1908 and the consumption private key 1910) and the consumption output ID 1912. For example, Node 1′s sensor measured x amount for consumption in time period y. Node 1 is adding this measurement to the blockchain using production token w, which proves the node is able to transact this energy.

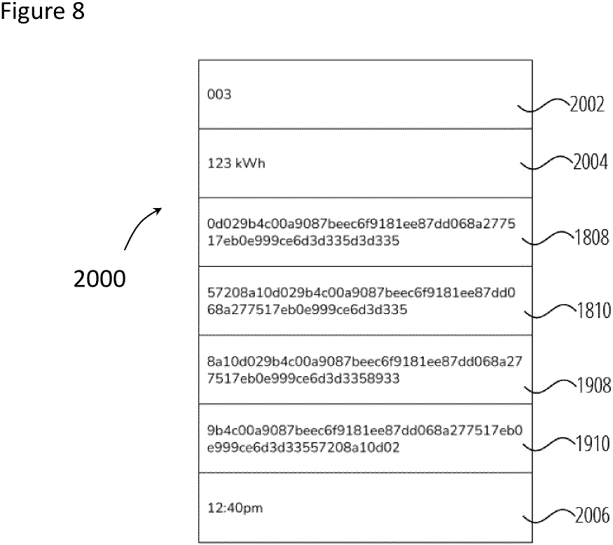

FIG. 8 illustrates an allocation transaction 2000 as in one embodiment. An allocation transaction is a log of energy transfer between peers. It includes the following data points: the allocation transaction id 2002, the amount transferred 2004, the production token key-pair (the production public key 1808 and the production private key 1810), the consumption token key-pair (the consumption public key 1908 and the consumption private key 1910) and the production allocation time period 2006.

Allocation transactions 2000 move ownership of production output from one node to another. There may be more than one allocation transaction 2000 needed to match the production or consumption. This is explained in the allocation process description. For example, Node 1, who produced x amount in production transaction y, wants to transfer ownership of this production to node 2 at time t to meet the node’s consumption transaction z.

An addendum is an additional data point linked to a transaction. It is not part of the transaction and can be added or modified after the creation. For example, status is stored with the transaction, though it is not part of the transaction. The status attribute is set to not spent when production has not been used yet, spent when the transaction is used to offset a consumption transaction 1900, or forked when it has been split into one or more transactions.

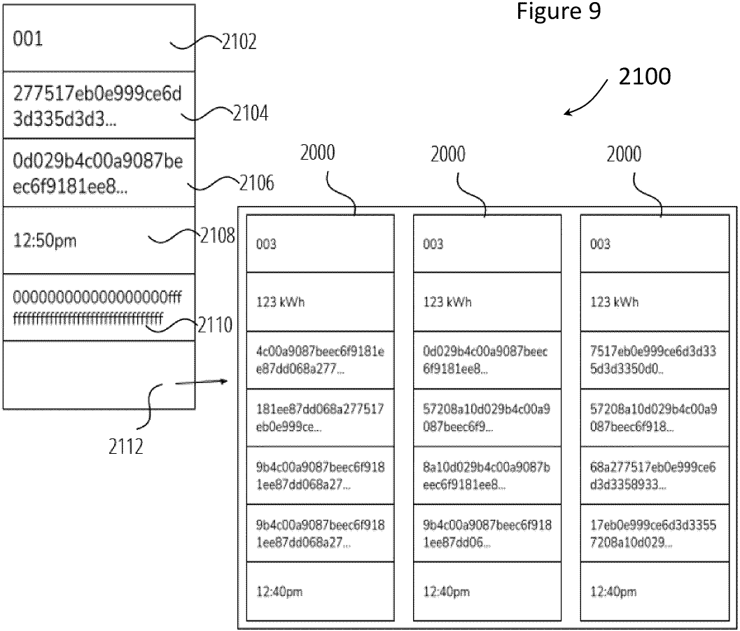

FIG. 9 illustrates a block example 2100 as in one embodiment. A block is a set of transactions grouped together and mined as a unit. They contain the following data points: the type of block 2102, the hash of the previous block 2104, the nonce 2106, the time period 2108, the difficulty 2110 and the set of transactions or tokens 2112, which are allocation transactions 2000 in this embodiment.

There are 4 different types of blocks: production blocks containing a set of production transactions 1800, consumption blocks containing a set of consumption transactions 1900, allocation blocks containing a set of allocation transactions 2000 and token blocks containing a set of tokens. Color is a tag or attribute associated with a block signifying a grouping. This attribute or color may be used for such purposes as the state of the blocks transactions, time since creation or source of origin of block.

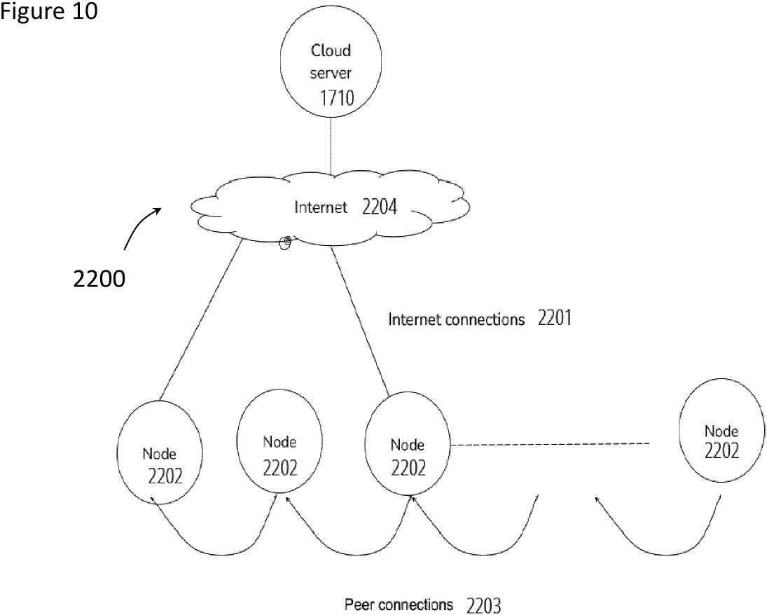

FIG. 10 illustrates a connection infrastructure 2200 as in one embodiment. There are two types of connection: Internet connections 2201 via the Internet 2204 and peer connections 2203.They can be established through one or more communication standards. Peer connections 2203 and Internet connections 2201 can happen over one or more physical connection mediums -such as wired, 3 g, 4 g, 5 g or community WIFI, etc. The peer connections 2203 and internet connections 2201 are typically over BT, zigbee, LoRa, Mesh WIFI, etc.

The coordination engine manages mining. It receives transactions from the nodes 2202, groups them into blocks and sends those blocks out to the mining pool(s). A coordinator node also delegates mining to all or a subset of nodes 2202 and, if applicable, it rotates mining among the subsets. If applicable, it also distributes power tokens.

In urban settings most or all nodes 2202 may have their own direct internet connections 2201 but in rural or remote settings, only some may have them. Peers can be contacted through the internet connection 2201 or by hopping along the peer connections 2203. The cloud 1710 is reached directly using one’s internet connection or by hopping along the peer connections 2203 to reach one that has an internet connection 2201 that facilitates through connectivity to the internet 2204.

The various entities community via channels through which they send and receive data. The embedded node has three types of channels: between itself and another embedded node, this channel is used to send and receive trade transactions and contracts; between itself and its avatar node, this channel is used to send and receive sensor measurements; and between itself and its connection infrastructure 2200, this channel is used to send and receive production transactions 1800, consumption transactions 1900 and trade allocation transactions 2000.

The avatar node also has three types of channels: between itself and another avatar node, this channel is used to send and receive trade transactions and contracts; between itself and its embedded node, this channel is used to send and receive sensor measurements; and between itself and its coordination engine, this channel is used to send and receive production transactions 1800, consumption transactions 1900 and trade allocation transactions 2000.

The coordination engine has three types of channels: between itself and the nodes 2202 it manages, this channel is used to send and receive production transactions 1800, consumption transactions 1900 and trade transactions; between itself and an allocation engine, this channel is used to send and receive blocks; and between itself and another coordination engine, this channel is used to send and receive transactions or blocks.

The allocation engine has two types of channels: between itself and the coordination engine, this channel is used to send and receive blocks; and between itself and another allocation engine, this channel is used to send and receive transactions or blocks.

Data is sent in envelopes that can be transmitted in unicast, multicast, or broadcast. The measurements envelope is used to send packages containing sensor measurements. The transaction envelope is used to send packages containing transactions. The block envelope is used to send packages containing blocks. The notice envelope is used to send packages containing notices of transaction completion.

Mining a block means finding a hash for the block with difficulty 2110 less than the current target set by the latest block. Standard blockchain hashing functions, such as SHA-256, are replaced with lightweight hashing functions that have smaller outputs, cycle rate, throughput rate, power consumption and area, for example PHOTON, SPONGENT, Quark, Neiva, ARMADILLO, Lesamnta-LW, Tav-128. In addition to the computational benefits, the reduction in size of public-private key pairs and of block hashes leads to overall more compact blocks.

Blocks are mined by nodes 2202 following instructions by the coordination engine in the following steps: Nodes 2202 send transactions to the coordinator, the coordinator groups the transactions into a block, the coordinator sets difficulty 2110 and sends the block to the mining pool. Nodes 2202 mine the block, the hash is found by node, the block is sent to the coordinator for verification and the coordinator distributes the block.

Mining difficulty 2110 is set by the coordination engine0 (the coordinator) by considering factors such as number of active nodes 2202 and duration of interval between trade transactions or production transactions 1800. The allocation engine is responsible for transferring energy between peers. It is configured with the following parameters: list of peers, trade parameters, configuration and pricing table.

The allocation engine can operate in 3 different modes. In the case of autonomous/involuntary allocation the allocation engine receives blocks for the interval, extracts consumption transactions 1900 and production transactions 1800 from the blocks, assigns production to consumption according to the allocation method selected, and makes trade transactions for each assignment, collects all the trade transactions, and makes a trade block for the interval and sends the block to the mining pool. Once the block is mined, the block is added to a blockchain 1704.

In the case of bids and offers allocation the allocation engine receives all transactions in blocks for the interval. Each production or consumption transaction is accompanied by its own price and fall back price. The engine sends offers to the offer pool and bids to the bid pool. The engine matches offers with bids, creates trade transactions for matches, collects all trade transactions into a trade block and sends the trade block to the mining pool. Once the block is mined, the block is added to blockchain 1704.

In the case of pre-production contracts, contract creation may be accomplished in the following steps: Node 1 offers to sell peer node 2 x units at price point y in a time period z, Node 2 accepts the offer and Node 1 and node 2 make a contract and send it in envelope to the allocation engine. Contract execution may be accomplished in the following steps: The engine stores envelope pool for interval. Once interval z arrives, the engine allocates energy according to contract, adds the transaction to its list of trade transactions and sends a trade block to the mining pool. Once the block is mined, the block is added to blockchain 1704. Note: if production during the interval is in excess of the amount stipulated by the contract, the remaining production is allocated through one or more of the other methods.

There are 2 different workflows for block creation and distribution. These workflows may run concurrently or one or the other may be interrupted or absent. These scenarios are described later. In the case of the cloud flow, the cloud 1710 is in charge of creating and distributing blocks in the following steps: sensor measurements are collected by embedded nodes 2202, the node 2202 sends the sensor measurements to its avatar in the cloud 1710, the avatar node 2202 creates a transaction, the transaction is sent to the cloud coordination engine (the coordinator) and the coordinator adds the transaction to a block. Once the block is mined, the block is added to blockchain 1704. In the case cohort flow, a special node 2202 is selected to fill the role of coordinator in round-robin fashion in the following steps: the sensor measurements are collected, the node 2202 creates a transaction, the transaction is sent to the coordinator and the transaction is added to a block. Once the block is mined, the block is added to blockchain 1704.

The subservient flow has two entities: a main and a shadow. In the standard state, the main workflow and shadow workflow are both active. Transactions are recorded by main flow and notices of transactions are recorded by shadow flow. In the transition state, the shadow workflow assumes the role of main. The shadow detects main is down and records the last notice received and transitions to the secondary blockchain 1704, on which it will start recording transactions. In the isolated state, only the shadow is active, where the shadow records transactions. In the synchronization state, the main workflow is reinstated.

The shadow detects main active, sends the transactions it recorded to main, transitions to primary blockchain 1704 and resumes recording notices (for example, main cloud flow and shadow cohort flow).

In the standard state, a production and consumption loop may comprise the following steps: sensor measurements are collected, the node 2202 sends measurements to its avatar in the cloud 1710 and the avatar node 2202 creates a transaction. In the case of autonomous allocation, with the sensor measurements alone, in the case of bid/offers allocation, with the sensor measurements and with a price range and in the case of a pre- production contract, with the sensor measurements, the price and the buyer’s public key. The transaction is sent to the cloud 1710 mining pool and added to a block, the block is mined and added to blockchain 1704 a notice is sent to the cohort and to node 2202, the node 2202 sends notice to the cohort mining pool and is added to a block. Once the block is mined, the block is added to blockchain 1704.

Furthermore, an allocation loop may comprise the following steps: the allocation engine tallies consumption and production for the interval, assigns production to consumption according to the allocation method selected, modifies an addendum to signal transaction, sends a notice a node 2202, the node 2202 sends notice to mining pool and is added to a block. Once the block is mined, the block is added to blockchain 1704.

In the transition state, a cohort detects main is down and records the last notice received and transitions to the secondary blockchain 1704, on which it will start recording transactions. In the isolated state, the sensor measurements are collected, a node 2202 creates a transaction that is sent to the cohort mining pool and added to a block. Once the block is mined, the block is added to blockchain 1704. In the synchronization state, the cohort detects main active and sends the transactions it recorded to the cloud’s 1710 mining pool. The cloud 1710 records blocks in its blockchain 1704 and resumes its main role and the cohort transitions to primary blockchain 1704, and resumes recording notices.

The collaborative flow has two entities: main a, main b. Note: main a and main b are interchangeable in this description. In the standard state, main a workflow and main b workflow are both active, transactions are recorded by main a flow and transactions are recorded by main b flow. In the transition state, main a is inactive. In the isolated state, main b is active, and transactions are recorded by main b flow. In the synchronization state, main a workflow is re-activated. Main a queries main b for transactions it missed, main b sends the transactions it recorded to main a and main a records the transactions (example main cloud flow and main cohort flow). In the standard state, a production and consumption loop may comprise the following steps: sensor measurements are collected, the node 2202 sends the sensor measurements to its avatar in the cloud 1710, the avatar node 2202 creates a transaction. In the case of autonomous allocation, with the sensor measurements and without a price, in the case of bid/offers allocation, with the sensor measurements and with a price range and in the case of a pre-production contract, with the sensor measurements, a price and the buyer’s public key. A transaction is sent to the cloud 1710 mining pool and to the cohort mining pool and added to a block in the cloud 1710 and in cohort. Once the block is mined, the block is added to blockchain 1704. The allocation loop may comprise the following steps: the allocation engine tallies consumption and production for the interval, assigns production to consumption according to the allocation method selected and modifies addendum to signal transaction.

In the transition state, the cohort detects if the main is down. When the first node 2202 to lose connectivity signals this, all nodes 2202 in the cohort may take a presumptive stance to follow in case the interruption is not temporary. The cohort notes the last transaction recorded by the cloud 1710 and continues as usual. In the isolated state, the sensor measurements are collected, the node 2202 creates a transaction, the transaction is sent to the cohort mining pool and is added to a block. Once the block is mined, the block is added to blockchain 1704. In the synchronization state, the cohort detects the main active, sends the transactions it recorded to cloud’s 1710 mining pool, records blocks in its blockchain 1704 and resumes recording of new transactions.

The complementary has two entities: main flow, alternative flow. In the standard state, the main workflow is active, and the transactions are recorded by main flow. In the transition state the main is inactive, an alternative detects the main flow is inactive and an alternative flow is activated. In the isolated state, an alternative flow is active, and transactions are recorded by alternative flow. In the synchronization state a main workflow is re-activated. The main queries alternative for transactions it missed, an alternative sends the transactions it recorded to main and the main records transactions (for example main cloud flow and alternative cohort flow). In the standard state, a production and consumption loop may comprise the following steps: the sensor measurements are collected, the node 2202 sends the sensor measurements to its avatar in the cloud 1710, the avatar node 2202 creates a transaction. In the case of autonomous allocation, with the sensor measurements and without a price, in the case of bid/offers allocation, with the sensor measurements and with a price range and in the case of a pre-production contract, with the sensor measurements, a price and the buyer’s public key. A transaction is sent to the cloud 1710 mining pool and is added to a block. Once the block is mined, the block is added to blockchain 1704.

Furthermore, an allocation loop may comprise the following steps: the allocation engine tallies consumption and production for the interval, assigns production to consumption according to the allocation method selected and modifies addendum to signal transaction.

In the transition state, the cohort detects main is down and notes the last transaction recorded by the cloud 1710 and continues as usual. In the isolated state, the sensor measurements are collected, the nodes 2202 create transactions, the transactions are sent to the cohort mining pool and are added to a block. Once the block is mined, the block is added to blockchain 1704. In the synchronization state, the cohort detects main active and sends the transactions it recorded to cloud’s 1710 mining pool. The cloud 1710 records blocks in its blockchain 1704, resumes recording of new transactions, queries the cohort for transactions it missed, sends the transactions it recorded to the cloud 1710 and records transactions and the cohort is then deactivated.

There exist three types of tokens: financing tokens, power tokens and consumer tokens. Using three separable tokenized representations enables the solution to handle the realities of local investment and digital currency laws and regulations and handles the variability in the value of currencies involved while avoiding any effect of such variations from affecting the power/energy trading loop/process. Financing tokens for project ICO (initial coin offering tokens) are purchased by investors. These tokens are converted into returns for the investors over the life-time of the system. Consumer tokens are purchased with fiat currency by consumers. Consumers can trade these tokens for power tokens. Power tokens are a means of strengthening security of measurements coming from devices and of tracing energy allocation. They serve as production validators by ensuring that prosumers cannot trade more production than their installation is capable of producing and as a tracer for transfers in ownership of production. There are two types of power tokens:

Production power tokens are used to sign production transactions into the blockchain. They may be assigned according to production capabilities and historical consumption. They may expire.

Consumption power tokens are used to sign production transactions into the blockchain. They may be assigned according to historical consumption. They may expire.

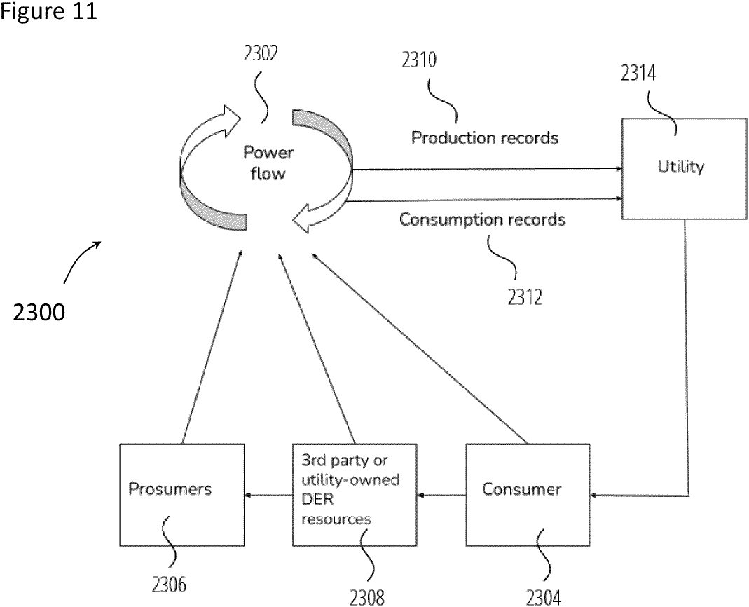

FIG. 11 illustrates a Utility and power flow diagram 2300 in one embodiment. The power flow 2302 receives sensor data from consumers 2304, prosumers 2306 and DERs 2308, and trades the energy available accordingly. The power flow is a token or coin based workflow that handles all the energy transactions, generates production records 2310 and consumption records 2312 and sends them to the utility 2314. This data is used to generate traditional records for billing and credits by utility.

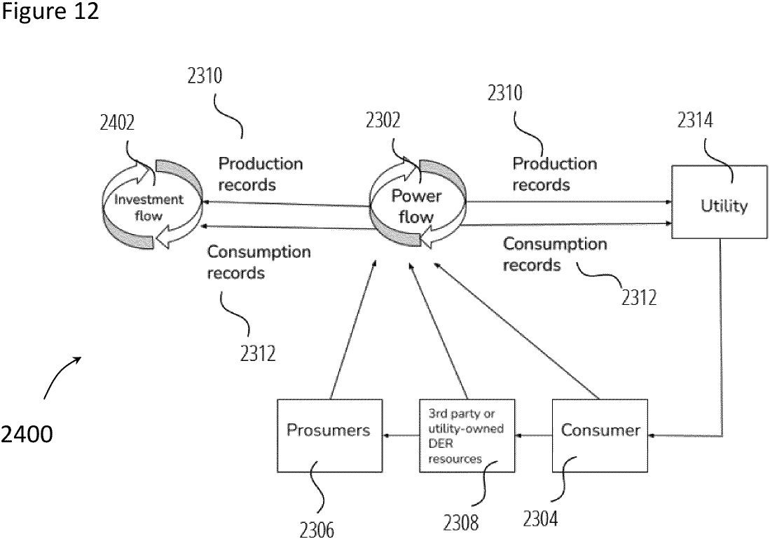

FIG. 12 illustrates an investment flow and power flow diagram 2400 in one embodiment. The investment flow 2402 is a token or coin based workflow to facilitate and manage investment into infrastructure and return value over its lifetime. The energy produced by the DERs 2308 is traded using the power flow 2302 and the corresponding value is delivered to the investor using the investment flow 2402. In this configuration, consumers 2304 and prosumers 2306 are billed for their use of energy in the traditional way using the production records 2310 and consumption records 2312 given to utility 2314 by the power flow 2302. By combining the power flow 2302 and the investment flow 2402, we create a method to convert real money and other investment into a form that can be transacted within the power flow 2302 and returns can be converted back to the investor.

For example, investors buy into projects using real currency or crypto currencies or by providing real services. In return they receive lifetime production worth of credit tokens. Tokens may be set up to ‘expire’ as and when production from assets is settled by actual production and trade. These tokens could end up being traded in a secondary market.

In the configuration presented in FIG. 12, consumers 2304 and prosumers 2306 are billed for their use of energy in the traditional way and do not have to use a digital currency or tokens or participate in the consumer flow 2502.

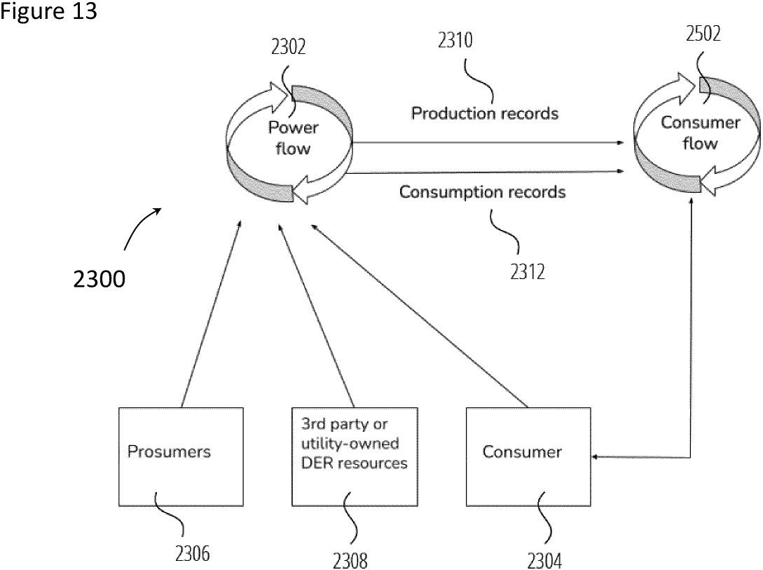

FIG. 13 illustrates a power flow and consumer flow diagram 2500 in one embodiment. Consumer flow 2502 is a token or coin based workflow to facilitate energy purchase by the end consumer. The power flow 2302 handles all the energy transactions, generates production records 2310 and consumption records 2312 and sends them to the consumer flow 2502. Consumers 2304 and prosumers 2306 use a tokenized or digital currency to pay or pre-pay for their energy use through the consumer flow 2502. In this configuration, infrastructure investment is performed in the traditional manner where utilities 2314, developers, prosumers 2306 and other third parties may spend their own capital for energy infrastructure (DERs 2308) and don’t participate in an investment flow 2402.

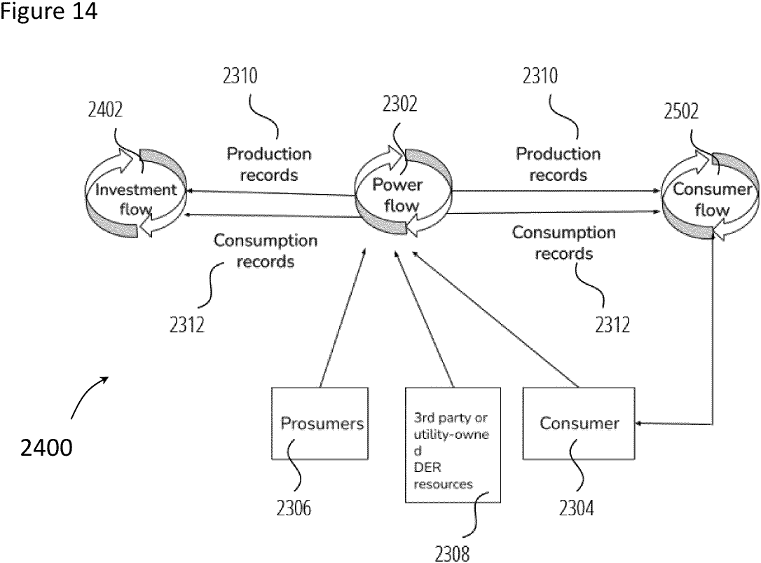

FIG. 14 illustrates an investment flow, power flow and consumer flow diagrams 2600 in one embodiment. This configuration represents the case where the investment flow 2402 and the consumer flow 2502 are both in place. The entire system is now based on digital currency or tokens. Investments in energy infrastructure are made using crypto currency or tokens. The energy produced by the DERs 2308 is traded using the power flow 2302 and the corresponding value is delivered to the investor using the investment flow 2402. Consumers 2304 and prosumers 2306 use a tokenized or digital currency to pay for or prepay for their energy use through the consumer flow 2502. The power token bridges the interface between the investment / dividend tokens and the consumer tokens by sending production records 2310 and consumption records 2312 to both.

In the fulfillment loop, power tokens are created and distributed to prosumers 2306 by a sub-loop. Prosumers 2306 produce energy and sensors measure the production and consumption. Production or consumption is signed with the appropriate number of tokens and added to the blockchain 1704 and peers trade production and consumption. In the token creation and distribution sub-loop, nodes 2202 make private/public key-pair and send them to the cloud 1710 or coordinator. The cloud 1710 or coordinator estimates consumption, makes tokens and signs them with public values. The coordinator sends the token block to mining pools and the block is mined in the standard method. In the end-consumer loop, the consumers 2304 purchase consumer tokens and store them in their wallets that may be pre- paid in fiat currency and/or earned by doing action. The consumers 2304 trade consumer tokens for power tokens, which they also store in their wallet. In the investment loop, the power production data is received from the fulfillment loop and the investors’ tokens get converted into money and expire.

Standard blockchain hashing functions are replaced with lightweight hashing functions which have smaller outputs and are easier to compute, for example PHOTON, SPONGENT, Keccak, Quark, Neiva, ARMADILLO, Lesamnta-LW, Tav-128. This reduces the size of public-private key pairs and of block hashes, leading to overall more compact blocks. Transactions can be recorded in full (i.e. containing all possible data points), in compressed form (i.e. some or all data points are compressed) or edited form (i.e. containing some but not all the data points). Transactions can transition between states as needed.

In self-managed purging, nodes 2202 elect to purge blocks without outside prompt. This occurs when the node 2202 reaches its memory capacity. Nodes follow the order of priority to purge blocks. In scheduled purging, the cloud 1710 or coordinator prompts nodes to purge blocks based on the order of priority. Ordering parameters include spent block, time of creation, external transactions and internal transactions (i.e. oldest spent external blocks get purged first and newest, unspent and internal blocks get deleted last).

For color-based expiration, colored blocks signifying purging order (ex. green blocks get purged first, yellow after, orange next, red last) may be implemented - for the same block in a blockchain 1704, nodes 2202 receive different colored blocks to increase odds that some copies are preserved in the event of purging. For example, a purging priority may be implemented where the spent green blocks are purged first, the spent yellow blocks and purged next, followed by the unspent orange blocks until the unspent red blocks are complete.

For time-based expiration, blocks are given expiry time on creation. Blocks that are expired are deleted first. The embedded blockchain network works in connection with the cloud 1710 but is also able to operate in isolation. The method and processes described provides the benefits of blockchain participation while tolerating the limitations mentioned.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

1. An energy trading method comprising:
utilizing a first processor, executing instruction stored on a first non-transitory memory configured to generate investment tokens for investors, who have funded an energy production project, and storing a record of the investment tokens on a first blockchain memory;
utilizing a second processor, executing instruction stored on a second non-transitory memory configured to generate power tokens in response to receiving sensor data from sensors at the energy production project as a record of energy production by the energy production project, and storing a record of the power tokens on a second blockchain memory;
utilizing a third processor, executing instruction stored on a third non-transitory memory configured to generate consumer tokens for consumers in exchange for currency for purchasing power tokens, and storing a record of the consumer tokens on a third blockchain memory;
providing power to the consumers in exchange for an amount of the consumer tokens; and
providing compensation to the investors as the power tokens are generated;
wherein the investment tokens the power tokens and the consumer tokens are untethered to any one cryptocurrency.

2. The method according to claim 1, further comprising purchasing power from a consumer in exchange for one or more power tokens.

3. The method according to claim 1, wherein the first blockchain memory, the second blockchain memory and the third blockchain memory comprise redundant block chain memories.

4. The method according to claim 1, further comprising measuring the amount of power provided to each the consumers with a power meter at each consumer’s location.

5. An energy trading system comprising:
a first processor, executing instruction stored on a first non-transitory memory configured to generate investment tokens for investors, who have funded an energy production project, and storing a record of the investment tokens on a first blockchain memory;
a sensor for generating sensor data of power generated as a record of energy production by the energy production project;
a second processor, executing instruction stored on a second non-transitory memory configured to generate power tokens in response to receiving the sensor data, and storing a record of the power tokens on a second blockchain memory;
the first processor also configured to exchange the investment tokens for compensation as the power tokens are generated in response to the sensor data; and
a third processor, executing instruction stored on a third non-transitory memory configured to generate consumer tokens for the consumers in exchange for currency for purchasing power tokens, and storing a record of the consumer tokens on a third blockchain memory, and configured to provide power to consumers in exchange for an amount of the consumer tokens;
wherein the investment tokens the power tokens and the consumer tokens are untethered to any one cryptocurrency.

6. The system according to claim 5, further comprising a power storage device configured for receiving power from a consumer in exchange for one or more power tokens.

7. The system according to claim 5, wherein the first blockchain memory, the second blockchain memory and the third blockchain memory comprise redundant block chain memories.

8. The system according to claim 5, further a power meter at each consumer’s location configured for measuring the amount of power provided.
